(19) United States
(12) Patent Application Publication
(10) Pub. No.: US 2012/0264492 A1
(43) Pub. Date: Oct. 18, 2012

(54) Hat Cell Phone Holder

(76) Inventor: Anthony Stewart, San Diego, CA (US)

(21) Appl. No.: 13/448,194

(22) Filed: Apr. 16, 2012

Related U.S. Application Data
(60) Provisional application No. 61/476,007, filed on Apr. 15, 2011.

(51) Int. Cl. H04M 1/00

(52) U.S. Cl. 455/575.2

(57) ABSTRACT

A cellular phone holding device designed to allow the practitioner to conduct conversations on the phone with limited physical interaction with the phone during activities or while performing manual tasks. The device holds the cellular phone in a pocket portion that attaches to a hat and properly aligns with the ear and cheek to facilitate communication. The device may involve hats of any style, shape, color or size. Further, the pocket portion of the device affixes to the inside or the outside of the hat depending on the need of the practitioner. In an alternative embodiment, the device is a pocket style holder for a cellular phone that removeably affixes to a hat or headpiece of any style, size or design.

### CROSS REFERENCE TO RELATED APPLICATION

This application claims the benefit of U.S. Provisional Application No. 61/476,007 filed on Apr. 15, 2011, entitled “Cell Phone Holder.”

### BACKGROUND OF THE INVENTION

1. Field of the Invention

The present invention relates to a hat with an attached pocket to carry a cellular telephone. More particularly, the present invention relates to a pouch for holding a cellular phone that is affixable to a hat.

The use of cellular telephones (cell phones) is increasingly widespread. One disadvantage however, is that they require the use of at least one hand to carry and another to dial or perform functions. Frequently cell phone users engage in activities such as driving or moving heavy objects that require the use of both hands, thus preventing consumers from making or answering important calls. To alleviate this issue, many consumers choose to use wireless accessories that allow for hands-free cell phone communication. However, these accessories are often uncomfortable to wear, as well as being small and easily lost. Consumers often need to purchase costly replacements for these wireless accessories, which is a further expensive inconvenience.

Ideally, there should be a solution that allows for the hands free use of a cellular phone during manual activities. Although voice-activated dialing is now available, the use of a standard cell phone is still somewhat awkward, particularly for those persons carrying out duties such as coaching, watching or taking part in sports and exercise endeavors or doing manual labor. It is desirable to provide a cellular phone carrying device that the practitioner carries on their person and requires minimal use of the hands, thus leaving the hands free to carry items or perform manual tasks during cell phone use. It would also be useful if the cellular phone could be held in place in a carrying pouch when inactive as well.

A hat provides an ideal medium for such a carrying device. Hats are available in a wide variety of styles, colors, materials and sizes. Further, it is possible to add one or more pockets to most any style of hat in a subtle and attractive manner. The pocket designs of the present invention are appropriate for the desired usage of the style of hat. For example, in a hat typically used during athletic events, the pockets may be made of a breathable material that may allow sweat and/or heat to dissipate from the wearer's head. For a hat used in the snow, the pocket might be designed to be located inside the hat to protect the phone from the elements. The pockets offer convenient, secure storage for a cellular phone during any sort of workout or manual labor. Pockets may also be made of a stretchable material for keeping items in place while running, and preferably have elastic openings. Most importantly, the pocket design holds the cellular phone in such a manner as to allow the user to listen and talk on the phone without requiring any hand usage.

The design of the cellular phone pocket should make for easy access to phone, allowing the practitioner to remove the cellular phone to dial or answer a call before replacing it back into the pocket. The cellular phone pocket may be provided with one or more small internal holes to facilitate the passage of sound during usage. Further, additional pockets may be provided at other locations on the hat, such as a pocket under the brim to carry other information. In such secondary pocket for example, a waterproof card may be carried containing emergency information, contacts, allergies, blood type, or other of the wearer's vital information.

The present invention will allow practitioners to use their cellular phones hands-free without the use of additional phone accessories. This device features a hat containing a pocket-like structure that is sewn or otherwise attached into the side of the hat in such a manner as to place it appropriately for use. The pocket securely holds a cell phone up to the user's ear and cheek for optimal communication. The pocket portion of this device can be attached to a variety of different types of hats, including baseball caps, beanies, winter hats, and several other styles of hats. Additionally, the device may come in a left or right sided version or may be moveable from one side to the other, to allow practitioners the choice of phone location. Further, in a second embodiment, the present invention will comprise of an attachable and removable pocket, allowing the user to affix the cellular phone pocket to a variety of different hats depending on the time and practitioner preference.

There is a need in the art for a device that allows the hands free usage of a cellular phone without the need of costly or easily misplaced accessories. Given the wide popularity and variety of styles of hats, the hat provides an ideal platform onto which a cellular phone holder may be attached. The present invention fulfills this need by providing a pocket device to hold the cellular phone during both use and inactivity, which is affixed to a wide variety of hats, thus suiting practitioner preferences.

2. Description of the Prior Art

Several applications have published related to the issues of cellular phone holders and hats with pockets. However, these prior art devices have known drawbacks or fail to specifically address the issue of carrying and using a cellular phone during manual activities.

Devices have been described that involve modifications of a hat to contain a variety of technologies. Duda, U.S. Patent Publication No. 2002/0186180 is directed to an apparatus into which the functional electronics components of popular consumer communications and entertainment products can be repackaged in a molded plastic module. The module mounts underneath and follows the contour of the visor of a head wearable cap/visor providing the user with a hands free, continuous power, multimedia capability. The module would feature a drop-down visual display, a drop-down camera lens for digital photography, a rechargeable battery, stereo speakers and earphones, a microphone and microphone boom, manual push button controls and LED indicator lights, input/output jacks, and an interactive voice capability. A flexible solar cell and antenna would be mounted on the upper surface of the head wearable cap/visor providing a wireless link and power to the electronics module.

The Duda publication describes a device that that is essentially a hat with a variety of multimedia technologies incorporated into its design. Such a device is clearly beyond the realm of need or desire for the typical individual who makes use of a cellular phone. The Duda invention is not designed to address the issue of cellular communication in a hands free manner; rather it is focused on the incorporation of a wide variety of technologies into a hat. Further, the inclusion of such a wide variety of complex and potentially fragile electronic devices makes the Duda invention less than ideal for users in active situations, such as a sport or other manual activity. The present invention is designed to be used when the practitioner is in an active situation, and thus cannot afford the incorporation with of a multitude of fragile gadgets, cords or functions. The present invention allows the user the ability to answer and to communicate via their cellular phone without the need of additional devices in a wide variety of situations.

Similarly to the Duda device, other devices currently described in prior applications include the incorporation of a variety of cellular phone related accessories into a hat. Parker, U.S. Patent Publication No. 2004/0204207 is directed to a hat, or baseball cap, modified to include a removable headset, having a speaker, microphone and a rear mounted pocket for holding a cell phone, the hat also having an internal flap and slits for running cords between the headset and the cell phone. The headset snaps into the hat to overhang the wearer's ear. A speaker is located near the ear, and a swiveling microphone arm is provided. A button on the microphone allows the wearer to answer calls, hang up, or activate phone voice recognition to make telephone calls. The headset and cell phone may be easily removed for cleaning by pulling away the cord holding flap, disconnecting it from the phone, removing the phone from the pocket and unsnapping the headset from the hat. The phone and headset system can be reinstalled on a similar hat.

The Parker device incorporates a variety of cell phone technologies within a hat. As with the Duda device, such incorporation creates difficulties in usage during manual or athletic activities. In addition to being impractical in a wide variety of uses, the Parker device requires such significant modification to a traditional hat as to make it potentially unsightly to users. The present invention provides a subtle addition to a traditional hat, and does not require the unsightly additions such as a microphone boom or control device.

Other devices described in the prior art address the issue of the addition of pockets to hats for general storage. Hosogai, U.S. Patent Publication No. 2006/0143776 is directed to a reversible hat with a visor that has pockets with closures. The hat is of the form of a baseball cap. The crown and front portions of the hat have a single layer of fabric, so that the hat is relatively lightweight and the crown portion can loosely drape into a relaxed shape. The closure for each pocket can be a zipper, Velcro, snaps or other suitable closure. The side portions of the hat have two layers of fabric lining the walls of the pocket. The visor has two layers of fabric with a middle layer of stiffening material. In some embodiments, the side portions and visor fabrics are of different colors and/or materials on the pocketed and unpocketed side of the hat. In some embodiments, the visor is detachably coupled to the front portion.

Similarly, Baldwin U.S. Patent Publication No. 2008/0016602 is directed to a contoured hat including a basket portion, a first pocket having a first elastic opening arranged on an outer surface of the basket portion, a brim portion, and a second pocket having a second elastic opening arranged on a surface of the brim portion. The pockets may be contoured and may include an elastic cord for adjustability. The pockets may also be elastically deformable and may contour objects contained therein to inhibit movement of the objects. The hat may be made from a flexible and breathable material throughout.

Both the Hosogai and Baldwin devices are hats designed to accommodate pockets for storage. While useful for the creation of a reversible hat or the carrying of a variety of papers, such devices are not optimized to address the issue of carrying a cellular phone. The present invention is designed to facilitate the carrying and use of a cellular phone during athletics or other manual activities. Devices such as the Hosogai and Baldwin inventions do not address such situations, instead focusing on the simple addition of pockets to the hat.

The present invention therefore substantially diverges in its design elements from the prior art and consequently it is clear that there is a need in the art for an improvement to existing cellular phone holder devices. In this regard the instant invention substantially fulfills these needs.

### SUMMARY OF THE INVENTION

In view of the foregoing disadvantages inherent in the known types of cellular phone carrying devices now present in the prior art, the present invention provides a new cellular phone carrying device wherein the same can be utilized for providing convenience for the user when a hat or other headwear is desired.

It is therefore an object of the present invention to provide a new and improved hat based cellular phone carrying device that has all of the advantages of the prior art and none of the disadvantages.

Another object of the present invention to provide a pocket device to carry the cellular phone, from which it may be easily removed and replaced for button presses and operation.

Another object of the present invention is to provide a pocket to hold a cellular telephone attached to a hat that facilitates conversation while allowing the user to engage in other activities that may require the use of his or her hands.

Yet another object of the present invention is to provide a stylish pocket addition to a wide variety of hats to suit practitioner needs and aesthetic desires.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 is a perspective view of the present invention in a ski hat style, with a cellular telephone in place for use.

FIG. 2 is a perspective view of the present invention in a baseball cap style.

FIG. 3 is a perspective view of the present invention in a winter hat style.

### DETAILED DESCRIPTION OF THE INVENTION

Reference is made herein to the attached drawings. Like reference numerals are used throughout the drawings to depict like or similar elements of the cellular phone carrying hat device. For the purposes of presenting a brief and clear description of the present invention, the preferred embodiment will be discussed as used for the containment and usage of a cellular telephone within a hat pocket. The figures are intended for representative purposes only and should not be considered to be limiting in any respect.

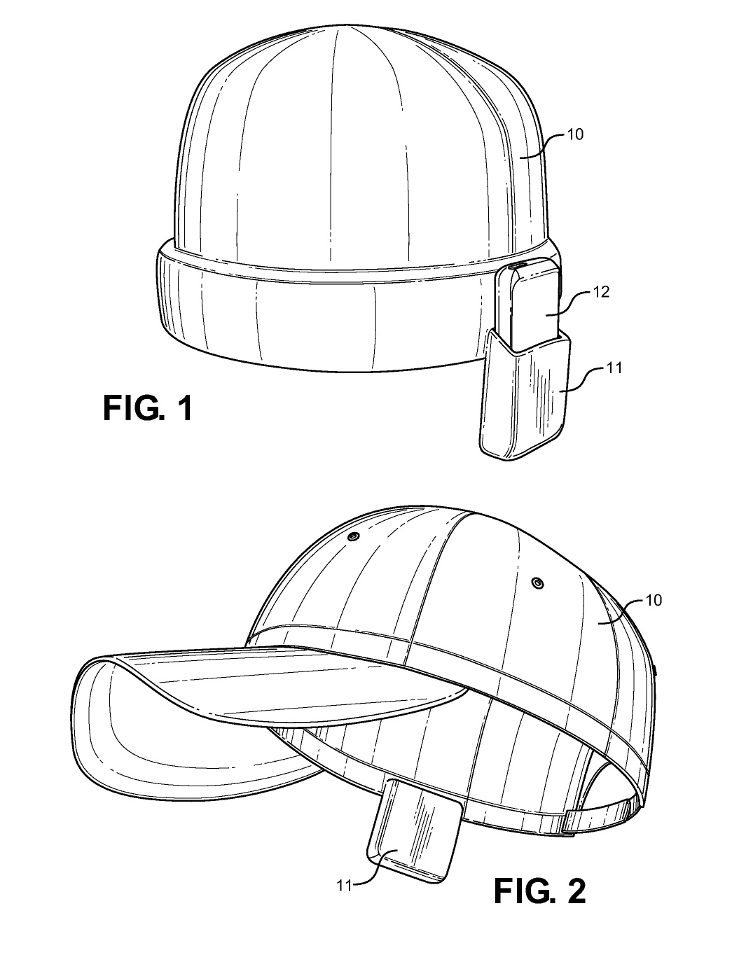

Referring now to FIG. 1, there is shown a perspective view of the present invention in a ski hat style, with a cellular telephone in place for use. A hat of any style 10 may be incorporated into the present invention. In this instance, a ski hat is used. A pocket portion 11 is attached such that in use the earpiece will properly be aligned with the practitioner's ear and the microphone will be properly aligned with the practitioner's cheek. A cellular phone 12 in the pocket device facilitates hands free usage and is easily accessible when needed.

Referring now to FIG. 2, there is shown a perspective view of the present invention in a baseball cap style. In this embodiment, the present invention is affixed to a baseball style cap, though it may be successfully implemented with any style of hat or headpiece 10. A pocket portion 11 attaches such that it properly aligns the cell phone to receive voice signals from the user and to provide the user with direct passage of sound from the cell phone speaker to the user's ear. In a baseball cap, or other athletic cap, it may be useful to attach the pocket portion 11 such that the cell phone will be within the cap during usage, thus further securing the phone during athletic or manual activities. When not in use, the pocket may be folded within the interior of the hat for concealment purposes.

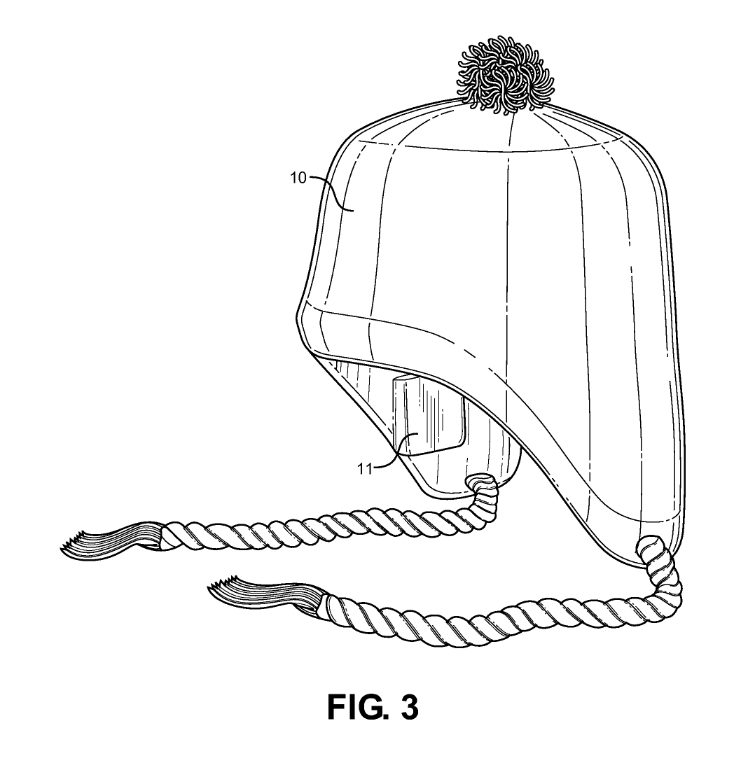

Referring now to FIG. 3, there is shown a perspective view of the present invention in a winter hat style. The present invention may be affixed to a hat of any style 10. In this instance, a tasseled winter hat is used. The pocket portion 11 may be affixed within the interior or exterior of the hat, depending on the application or preferences of the user. With a winter hat, ideally the phone pocket portion 11 would be incorporated inside the hat so that the phone is protected from the elements during use.

In use, an individual using the invention is able to use their cellular phone comfortably and in a hands free manner. The invention comprises a hat of any style 10 containing a pocket 11 designed to accommodate a cellular phone 12. The pocket 11 can be sewn or otherwise attached onto one side of the hat 10 or onto the outside of one side of the hat 10 depending on the application desired. For example, in hats 10 used in highly physical activities or in the elements (such as snow), it would be optimal to affix the pocket portion 11 inside the hat 10, thus protecting the cellular phone 12 from the environment and from dislodgement from the pocket 11. Additionally, the pocket portion 11 is positioned to place the cell phone next to the user's ear and mouth for clear communication and voice transmission.

The present invention may be produced in a variety of designs to suit practitioner preferences and needs. The pocket portion 11 may also be made of the same material used to construct the hat 10, allowing it to blend with the traditional construction of the hat 10. The pocket portion 11 can be made in a variety of sizes to accommodate different types of cell phones. Alternatively, the pocket portion 11 could be constructed of an elastic material, allowing it to stretch to fit a wide variety of phones. Further, the pocket portion 11 or the hat itself may have additional apertures added to correspond with the locations of the microphone and the speaker of the cellular phone 12. Such apertures will facilitate usage of the phone through the fabric of the hat or pocket. The basic design of the present invention allows practitioners a hands free means of using a cellular phone with limited impact on the aesthetics or complexity of their headgear.

Alternatively, this device may comprise of an embodiment of the pocket portion 11 that is removable and may be affixed to a variety of hats or headpieces 10. In such an embodiment, the present invention would comprise of a pocket portion 11 designed to hold a cellular telephone 12 and be affixable as desired to any hat or headpiece 10, including head bands, helmets or similar devices. The pocket portion could then be moved from one hat to another or from one side of the hat to the other as the practitioner desires, thus allowing greater flexibility than other devices. The means in which it may attach include hook and loop fastening, adhesive or similar affixing method known to one skilled in the art of hats and helmet accessories.

To this point, the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A cellular phone holding device, comprising:
a head piece adapted to attach to a user's head;
a pocket portion of such size as to suitably hold a cellular phone attached to said head piece, said attachment aligning said phone with said user's ear so as to facilitate communication;
and said pocket portion allowing quick removal and replacement of said cellular phone, while maintaining said cellular phone in position while said user is active.

2. The device as recited in claim 1, wherein said pocket portion is elastically deformable to accommodate different cellular phone geometries.

3. The device as recited in claim 1, wherein said pocket portion is removable and placeable on either side of said head piece.

4. The device as recited in claim 1, wherein additional pockets are attached to different portions of said head piece for storage of accessories, papers or other articles.

5. The device as recited in claim 1, wherein said pocket further comprises apertures next to said cellular phone speaker and microphone to facilitate clear communication.

6. A cellular phone holding device, comprising:
a pocket portion of such size as to suitably hold a cellular phone and removably attach to a head piece, said attachment aligning said phone with said user's ear so as to facilitate communication;
and said pocket portion allowing quick removal and replacement of said cellular phone, while maintaining said cellular phone in position while said user is active.

7. The cellular phone pocket as recited in claim 6, wherein said pocket further comprises apertures next to said cellular phone speaker and microphone to facilitate clear communication.

8. The device as recited in claim 6, wherein said pocket portion is elastically deformable to accommodate different cellular phone geometries.
